(19) United States
(12) Patent Application Publication
(10) Pub. No.: US 2006/0282275 A1
(43) Pub. Date: Dec. 14, 2006

(54) Survey Method for Facilitating Real Estate Transactions

(76) Inventors: Douglass D. Pineda, Longmont, CO (US); Christopher J. Hirai, Firestone, CO (US); Kevan L. Davidson, Longmont, CO (US)

Correspondence Address: CHRISTOPHER J. KULISH, ESQ, HOLLAND & HART LLP, P. O. BOX 8749, DENVER, CO, 80201-8749, US

(21) Appl. No.: 11/160,084

(22) Filed: Jun. 8, 2005

(51) Int. Cl. G06Q 99/00

(52) U.S. Cl. 705/1

(57) ABSTRACT

The present invention is directed to a dynamic survey for extracting data from a consumer that is contemplating a real estate transaction (e.g., the purchase or sale of a residence), processing the data to produce a report, and providing the report to the consumer. In one embodiment, a Web server transmits a query over the Web to a computing device associated with the consumer; the consumer causes the computing device to transmit an answer to the query back to the Web server; the Web server processes the answer to determine a subsequent query. The use of an answer to a query to determine a subsequent query typically occurs throughout the survey and results in the consumer providing answers to questions that are focused to the consumer, as opposed to be a general survey in which the answers to many queries are unlikely to provide data that is meaningful in facilitating the real estate transaction contemplated by a particular, individual consumer. In one embodiment, the queries are directed to: (a) identifying aspects of the consumer's personality that may impact the real estate transaction being contemplated and (b) expectations of the consumer with respect to the real estate professionals that the consumer may want to engage to facilitate the contemplated transaction. The answers to the series of queries are used to produce the report that is provided to the consumer. In another embodiment, the report is provided to a real estate professional that evaluates the report to determine if the real estate professional is: (a) a good fit with respect to the real estate transaction being contemplated by the consumer and the expectations of the consumer with respect to the type of real estate professional that the consumer would want to engage to assist the consumer in the contemplated real estate transaction or (b) if the real estate professional knows of another real estate professional that is such a fit. If the real estate professional decides that there is a good fit, one or more referral transactions occur and a real estate professional is introduced to the consumer.

### FIELD OF THE INVENTION

The present invention is directed to a real estate survey that a consumer who is contemplating a particular real estate transaction can take in an effort to facilitate the contemplated real estate transaction.

### BACKGROUND OF THE INVENTION

Presently, an owner of real property has a number of options as to the manner in which they can go about trying to sell their real property. The owner can place a sign on the property to advertise that the property is for sale to people passing by the property. This approach, however, typically provides limited exposure of the property to prospective buyers. In an effort to increase the number of potential buyers to which the property is exposed, the owner can place an advertisement in one or more newspapers. However, this approach commonly fails to expose the property to the type of potential buyers that would be interested in the property. Consequently, in many cases, the owner engages a real estate agent or broker that is tasked with promoting the sale of the property. The real estate agent or broker may, in promoting the sale of the property, place the property with a multi-listing service that provides other real estate agents or brokers with an opportunity to promote the sale of the property.

Individuals looking to buy real property also have a number of options as to the manner in which they can go about trying to buy a residential property. For instance, a prospective buyer can travel the streets in the area in which they are interested in obtaining real property to identify properties in which they might be interested and then approach the owner to determine if the owner has any interest in selling the property. This approach typically is not very efficient from a time perspective. Another approach that a prospective buyer may take is to peruse the classified advertisements in newspapers to identify properties in the areas in which they have an interest and then visit the property to assess whether they want to enter into negotiations to purchase the property. This approach is also quite time consuming in many cases. Consequently, many prospective buyers also engage a real estate agent or broker to assist them in identifying properties of interest. The real estate agent may, in this regard, consult multi-listing services to identify residential properties that may be of interest to the prospective buyer.

The arrival of the Internet has provided a new instrument by which an owner of real property can advertise that their property is for sale and prospective buyers can identify properties that they may be interested in purchasing. In this regard, Internet Web-sites have been developed that allow a prospective seller to list their property for sale. In listing their property, an owner typically provides the Web-site with statistical information on the residential property (e.g., square footage, no. of bedrooms, no. of bathrooms, etc.). The Web-site accumulates this statistical information for a number of residential properties in a database that can be searched by prospective buyers or their real estate agents or brokers. Typically, a prospective buyer or their agent/broker searches the database by providing information in response to a questionnaire that is displayed by the browser running on the computer of the prospective buyer or their agent. The Web-site, in response, provides the prospective buyer or their agent with a list of one or more properties that match the search criteria. Typically associated with each item in the list is the statistical information on the residential property that was provided by the prospective seller and one or more pictures of the property. In some cases, the prospective buyer or their agent is also able to take a virtual tour of a property using their browser.

### SUMMARY OF THE INVENTION

The present invention is directed to a method of conducting a survey to facilitate real estate transactions. In one embodiment, the method comprises using a dynamic survey to extract data from a consumer that is contemplating a real estate transaction (e.g., the purchase or sale of a residence), processing the data to produce a report, and providing the report to the consumer. The dynamic aspect of the survey involves receiving an answer from the consumer to a particular query in the survey and using the answer to determine a subsequent query that is posed to the consumer. The dynamic nature of the survey typically results in a survey with queries that are more relevant to, or focused on, the needs of the individual consumer taking the survey. Consequently, relative to a static survey, the consumer is less likely to have to address queries that are not relevant to the real estate transaction that is being contemplated. In a further embodiment, an additional report is generated and provided to a realtor or other individual that facilitates real estate related transactions.

In another embodiment, the method comprises using a survey that has a personality profiling characteristic to extract data from an individual that relates to a real estate transaction being contemplated by the individual, process the data to produce a report, and provides the report to the individual. The personality profiling characteristic of the survey allows a determination to be made as to the psychological type, within the context of the contemplated real estate transaction, of the individual taking the survey. The psychological type in such a context relates to the manner in which the individual is expected to perceive and judge things within the context of the contemplated real estate transaction. By using such a survey, it is believed that the resulting report will provide the individual consumer with a richer and more three-dimensional understanding of their wants and needs with respect to the contemplated real estate transaction. In a further embodiment, an additional report is generated and provided to a realtor or other individual that facilitates real estate related transactions.

In one embodiment, a method for conducting a survey to facilitate real estate transactions is implemented using a Web server that communicates, via the Internet, with a user computing device that is running an Internet browser and associated with the consumer that is contemplating a real estate transaction. More specifically, the Web server initially receive a signal from the user computing device indicating that the consumer wants to take the survey. In response, the Web server transmits a query that is directed to the user computing device and designed to extract data from the individual that is relevant to the contemplated real estate transaction. The browser running on the user computing device causes the query to be displayed to the consumer and provides an interface that allows the consumer to provide an answer to the query. Subsequently, the Web server receives an answer to the query that has been transmitted from the user computing device. The Web server processes the answer to determine a subsequent query that is based on the answer to the prior query. After the second query has been determined, the Web server causes the second query to be transmitted to the user computing device for consideration by the consumer. The use of an answer to one query to determine a subsequent query may be done multiple times over the course of a single survey. Further, an answer to one query may determine more than one than one subsequent query. In one embodiment, the queries have a personality profiling characteristic that is designed to yield a psychological typing of the consumer's individuality with respect to the contemplated real estate transaction and/or the consumer's expectations with real estate personnel that the consumer is likely to employ in investigating the contemplated transaction.

### BRIEF DESCRIPTION OF THE DRAWINGS

FIG. 1 is a block diagram of an embodiment of a communication system that is capable of being used to practice the real estate survey method of the present invention;

FIG. 2 illustrates an embodiment of a process flow within which an embodiment of the survey method operates;

FIGS. 3A and 3B graphically illustrates the operation of an embodiment of a dynamic real estate oriented survey;

FIGS. 4A and 4B illustrate a first page of a dynamic survey that is transmitted to a user computing device with the user's answers to the queries on the page;

FIG. 4C illustrates a second page of the survey that is subsequently transmitted to the user computer device;

FIGS. 4D and 4E illustrates the first page of the dynamic survey shown in FIGS. 4A and 4B with one change to the user's answers to the queries on the page relative to the answers shown in FIGS. 4A and 4B;

FIG. 4F illustrates the second page of the survey that is subsequently transmitted to a user computer device;

FIGS. 5A and 5B illustrate a first page of a Jungian-style real estate survey that is transmitted to a user computing device; and

FIG. 6 is an example of pre-written text that is inserted into a consumer's report based upon the consumer's answer to a survey query satisfying a condition for insertion of pre-written text into the report; and

FIGS. 7A-7F is an example of a consumer's report that is constructed from pre-written text that has been inserted into a report template based upon the consumer's answers to the survey questions;

FIG. 8 is an example of pre-written text that is inserted into a referral agent or real estate professional's report based upon the consumer's answer to a survey query satisfying a condition for insertion of pre-written text into the report; and

FIGS. 9A-9G is an example of a referral agent's report that is constructed from pre-written text that has been inserted into a report template based upon the consumer's answers to the survey questions.

### DETAILED DESCRIPTION

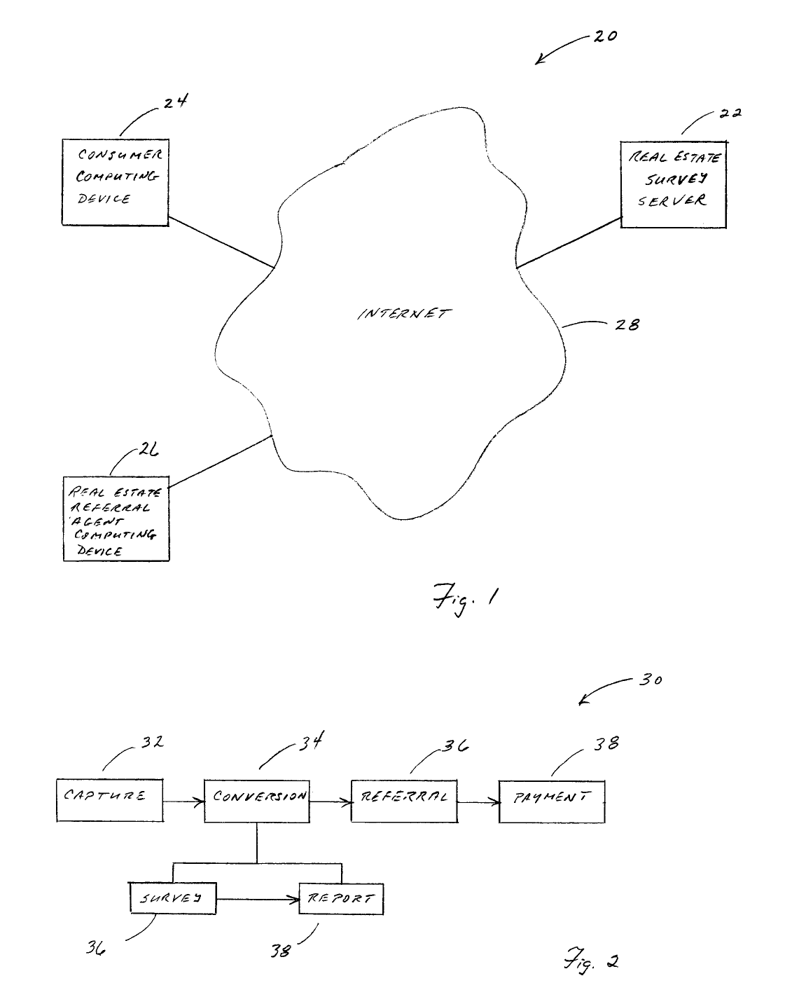

FIG. 1 illustrates an embodiment of a computer network system 20 that is capable of being used by a consumer to take a real estate survey that facilitates a predetermined type of real estate transaction(e.g., a real estate purchase transaction, a real estate sales transaction, or a real estate lease transaction). The system comprises a real estate survey server 22, a consumer or user computing device 24 that is associated with the consumer of the survey, a real estate referral agent computing device 26 that is associated with a real estate referral agent that potentially assists the consumer in the contemplated real estate transaction, and a computer network 28 (e.g., the Internet) that facilitates communications between the server 22, consumer computing device 24, and the real estate referral agent computing device 26.

The real estate survey server 22 includes or has access to a real estate survey comprised or a plurality of queries, provides the survey to the user computing device 24 via the network 28, processes the answers of the consumer to the queries in the survey that are received from the network 28, produces a report for the consumer that facilitates the real estate transaction being contemplated by the consumer, and provides the report to the user computing device 24 via the network 28 for consideration by the consumer. In addition, if the consumer wants the assistance of a real estate professional in moving forward with the contemplated real estate transaction, the server 22 provides a version of the report to the real estate referral agent computing device 26 via the network 28 for consideration by the real estate referral agent associated with the device 26.

The consumer computing device 24 is a device that is capable of communicating with the server 22 via the network 28 and, if desired, the real estate referral agent computing device 26 via the network 28. Consequently, the consumer computing device 24 is comprised of a network interface that facilitates such communications. The network interface can be wired or wireless. The consumer computing device 24 is further able to transmit or convey to the consumer a query associated with the survey, a portion or all of the report, and other communications from the server 22 or the real estate referral agent computing device 26. Consequently, the device 24 has a user interface comprised of an output device for transmitting such communications to the consumer. The output device is typically a video monitor. However, any type of output device that is capable of transmitting such a communication to the consumer in a manner that can be sensed by the consumer is feasible. For example, a speaker or a printer is feasible. The device 24 is also able to receive an answer of the consumer to a query associated with the survey and other communications that the consumer wants to convey to the server 22 or the real estate referral agent computing device 26. Consequently, the user interface is further comprised of an input device for receiving such communications from the consumer. The input device is typically a keyboard and/or mouse. However, any type of input device that is capable of receiving a communication from the consumer is feasible. For instance, a microphone or a camera is feasible. It should be further appreciated that the consumer computing device 24 can be a stationary device (e.g., a kiosk-style computing device, desk-top computer, workstation etc.) or a portable device (e.g., a personal digital assistant (PDA) or cell phone). The consumer computing device 24 also has a software application that facilitates standardized communications with the server 22 and the real estate referral agent computing device 26 via the network 28. In the illustrated embodiment, the software application is a Web browser. However, other applications that are adapted for communications on other types of networks are also feasible.

The real estate referral agent computing device 26 is a device that is capable of communicating with the server 22 via the network 28 and, if desired by the consumer, the consumer computing device 24 via the network 28. The device 26 is comprised of a network interface that facilitates such communications. The network interface can be wired or wireless. The real estate referral agent computing device 26 is further able to transmit or convey to the real estate referral agent all or a portion of the noted version of the report to the real estate referral agent and other communications from the server 22 or the consumer computing device 24. Consequently, the device 26 has a user interface comprised of an output device for transmitting such communications to the real estate referral agent. The output device is typically a video monitor. However, any type of output device that is capable of transmitting such communications to the real estate referral agent in a manner that can be sensed by the real estate referral agent is feasible. For example, a speaker or a printer is feasible. The device 26 is also able to receive communications from the real estate referral agent that the real estate referral agent wants to convey to the server 22 or the consumer computing device 24. Consequently, the user interface is further comprised of an input device for receiving such communications from the real estate referral agent. The input device is typically a keyboard and/or mouse. However, any type of input device that is capable of receiving a communication from the real estate referral agent is feasible. For instance, a microphone or a camera is feasible. It should be further appreciated that the real estate referral agent computing device 26 can be a stationary device (e.g., a kiosk-style computing device, desk-top computer, workstation etc.) or a portable device (e.g., a personal digital assistant (PDA) or cell phone). The real estate referral agent computing device 24 also has a software application that facilitates standardized communications with the server 22 and the real estate referral agent computing device 26 via the network 28. In the illustrated embodiment, the software application is a Web browser. However, other applications that are adapted for use on other types of networks are also feasible.

FIG. 2 illustrates an embodiment of a process flow 30 within which an embodiment of the survey method operates. The process flow 30 is comprised of a capture step 32 in which consumers are attracted to a Web-site that offers the survey; a conversion step 34 in which a captured consumer takes the survey and is provided with a report setting forth the results of the survey with respect to the real estate transaction being contemplated by the consumer; a referral step 36 in which, if desired, the consumer is referred to a real estate professional that may assist the consumer in proceeding with the contemplated real estate transaction; and a payment step 38 in which one or more real estate professionals provides compensation for the referral of the consumer to them.

The capture step 32 comprises one or more methods for attracting the consumer associated with the consumer computer device 24 to a Web-page provided by the real estate survey server 22 and at which the consumer can initiate the survey. Among the possible methods for implementing the capture step are: (a) configuring the web-site so as to achieve a higher ranking by a search engine and thereby appear higher in the search results when a consumer utilizes a search engine to obtain information that may relate to the contemplated real estate transaction; (b) an advertising campaign in which navigational information is provided to the consumer when the consumer views advertising literature that can be placed in any number of locales (e.g., real estate advertisements in newspapers, real estate magazines, Web-based real estate referral directories); and (c) configuring the web-site to provide information related to the real estate transaction being contemplated by the consumer (e.g., grade school information in the real estate market in which the consumer is contemplating buying a house) that is likely to appear in a consumer's search results list and to provide the consumer with an opportunity to also take the survey.

The conversion step 34 comprises: (a) a taking of the survey step 42; and (b) a generating a report based on the consumer's answers to queries within the survey and providing the report to the consumer step 44. The taking of the survey by the consumer assumes, as a starting point, that the consumer computing device 24 is displaying or otherwise conveying to the consumer a Web page that has been conveyed to the device 24 from the server 22 via the network 28 and that the Web page provides a basis for the consumer indicating a desire to initiate the survey process. While the Web page for initiating the survey and the subsequent Web pages associated with the survey and report or reports that are generated based on answers to the survey are implemented in html, it should be appreciated that the survey interface can be implemented using different languages and applications, such as Flash. The consumer indicates a desire to take the survey by using the user interface associated with the consumer computing device 24 so as to cause a signal that indicates the consumer's desire to be transmitted from the device and directed to the server 22. The signal is conveyed by the network 28 to the server 22.

In response to the initiate survey signal, the server 22 initiates a dynamic survey dialog with the consumer in which the consumer's answer to a query posed by the server 22 is processed or analyzed by the server 22 to determine a subsequent query. Given that there are two or more answers to each query and individual consumers are unlikely to answer each query in the same way, the survey given to a particular consumer is typically quite individualized relative to the dynamic survey given to other consumers. Moreover, because of this individualization, the survey given to a consumer is likely to have significantly fewer questions and require less time to take than a survey that is unable to determine, based on an answer to a query, a subsequent query to be provided to the consumer.

The dynamic survey dialog commences with the server 22 causing a transmission of a first query to be directed to the consumer computing device 24. The first query is conveyed by the network 28 to the consumer computing device 24. The consumer computing device 24 receives the first query from the server 22 and displays or otherwise conveys the first query to the consumer for consideration. The first query requests an answer or answers to the query from the consumer and provides a basis for the consumer to provide the answer or answers. Typically, the consumer selects the answer or answers from a predetermined set of options that are associated with or part of the query and that are displayed or otherwise conveyed to the consumer by the device 24. The consumer manipulates the user interface associated with the consumer computing device 24 to cause transmission of the answer or answers from the device 24 to be directed to the server 22. The answer or answers is/are conveyed by the network 28 to the server 22. In response to the answer or answers to the first query, the server 22 processes the answer or answers to determine a second query. Subsequently, the server 22 causes a transmission of the second query to be directed to the consumer computing device 24. The second query is conveyed by the network 28 to the consumer computing device 24, which displays or otherwise conveys the second query to the consumer for consideration and answer. The process of using an answer to one query to determine a subsequent query may occur several times during the survey. Moreover, the answer or answers to two or more queries may be used to determine a subsequent query. Further, it should be appreciated that the second query may immediately following the first query or be separated from the first query by one or more intermediate queries.

With reference to FIGS. 3A and 3B, one method of implementing the dynamic survey is illustrated. FIG. 3A illustrates a survey 50 prior to the conveyance of the first query in the survey or first set of queries in the survey from the server 22 to the consumer computing device 24. The survey 50 is comprised of a plurality of queries, each query being represented by a circle. The plurality of queries is divided into pages. In the illustrated case, the queries are divided into pages 1-6. Each page represents a web-page that is transmitted from the server 22 to the consumer computing device 24 via the network 28. Each page initially has one or more queries. Further, each page is associated with a particular subject that is or may be of relevance in assessing the consumer's motivations with respect to the contemplated real estate transaction. In the illustrated embodiment, one or more pages are associated with each of the subjects of the consumer's personality, the consumer's lifestyle, the consumer's priorities, and the consumer expectations with respect to any real estate professional that may later assist them in furthering the contemplated real estate transaction.

The survey commences with the server 22 causing the transmission of page 1 of the survey to be directed to the consumer computing device 24. Page 1 is conveyed by the network 28 to the consumer computing device 24. The consumer computing device 24 receives page 1 of the survey from the server 22 and displays or otherwise conveys page 1 to the consumer for consideration. Page 1 requests an answer or answers to each of the queries associated with the page (in this case, three queries) from the consumer. Associated with or part of each query on page 1 are two or more predetermined, potential answers that are displayed or otherwise conveyed to the consumer. Associated with each answer is an interface that allows the user to select at least one of the answers associated with a particular query. The consumer manipulates the user interface associated with the consumer computing device 24 to select an answer associated with a query. In the illustrated embodiment, a “radio button” is associated with each of the potential answers. The consumer selects an answer by using a mouse to click on the button associated with the desired answer. It should be appreciated that there are at least two types of queries. In the first type of query, the user is only allowed to select one of the two or more answers that are associated with or part of the query. In the second type of query, the user is allowed to select two or more answers of the two or more potential answers that are associated with or part of the query.

Once the consumer has finished selecting all of the answers for the queries associated with page 1, the consumer computing device 24 causes a transmission of the answers to the server 22. The network 28 conveys the answers to the server 22. The answers are, in turn, received by the server 22. The server 22 analyzes or processes the answers and, in so doing, determines second or subsequent queries that will be provided to the consumer based on one or more of the consumer's answers to the queries associated with page 1. To elaborate, the server 22 is able, based on the analysis of an answer, to delete or modify a question associated with a page that may subsequently be transmitted to the consumer. If all of the questions associated with a page are deleted, the page is not transmitted to the consumer and the next subsequent page with at least one question is transmitted to the consumer, until the final page is transmitted to the consumer. Modification of a query can take any of several forms. Among the possible modifications is the deletion of an answer from the query and the filling in of a blank associated with the query with data from or information gleaned from one or more answers received from the consumer.

With respect to the example illustrated in FIG. 3B, analysis of the consumer's answers (answers are indicated by triangles) to the queries associated with page 1 of the survey by the server 22 results in three queries from page 2 being deleted (deletions are indicated by the absence of a circle in a location previously occupied by a circle), one query from each of pages 3 and 4 being deleted, three queries from page 5 being deleted, and one query from page 6 being deleted. In addition, a query associated with each of pages 3, 4 and 5 is modified (modification indicated by an “M” within a circle at a location previously, solely occupied by a circle).

FIGS. 4A-4F illustrate an example of the deletions or modifications of the queries associated with a page of a survey for an individual consumer that is contemplating a residential real estate transaction relating to residential property. Specifically, FIGS. 4A-4B illustrate a first page of a survey provided by the server 22 to the consumer computing device 24 in which the subject matter or focus of the queries is on the consumer's lifestyle. FIGS. 4A-4B also shows the consumer's answers to the queries posed on the page. FIG. 4C illustrates a subsequent page of the survey provided by the server 22 to the consumer computing device 24 in which the subject matter or focus of the queries is one the consumer's priorities. Notice that the queries associated with the subsequent page are highly correlated to the consumer's answer of the suburbs in reply to the lifestyle query as to where the consumer is looking for a home. FIGS. 4d-4E illustrate the same page of the survey as illustrated in FIGS. 4A-4B. However, the consumer's answer to the lifestyle query as to where the consumer is looking for a home has been changed to the city. FIG. 4F shows the same page of the survey as shown in FIG. 4C. However, a comparison of the queries shown in FIG. 4C as being associated with the page and the queries shown in FIG. 4F as being associated with the same page shows that the server 22 has processed the suburbs/city answers so that the queries on the subsequent page are totally dissimilar. It should be appreciated that the survey is capable of being adapted to commercial real estate transactions that are contemplated by an individual or corporate entity.

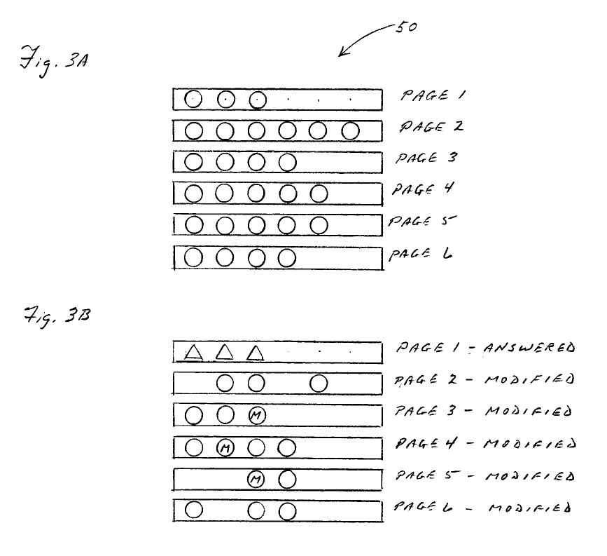

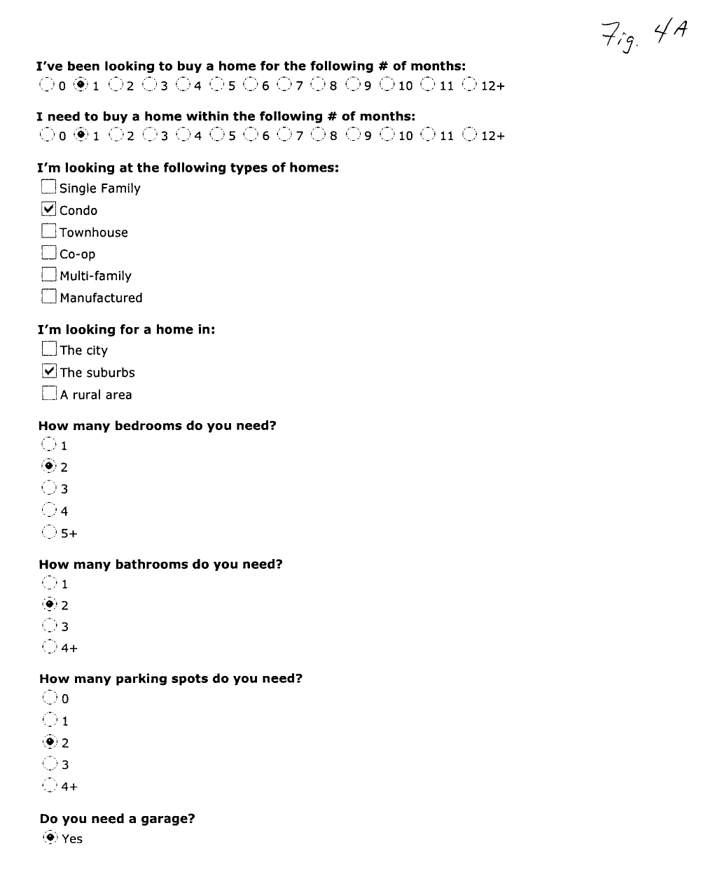

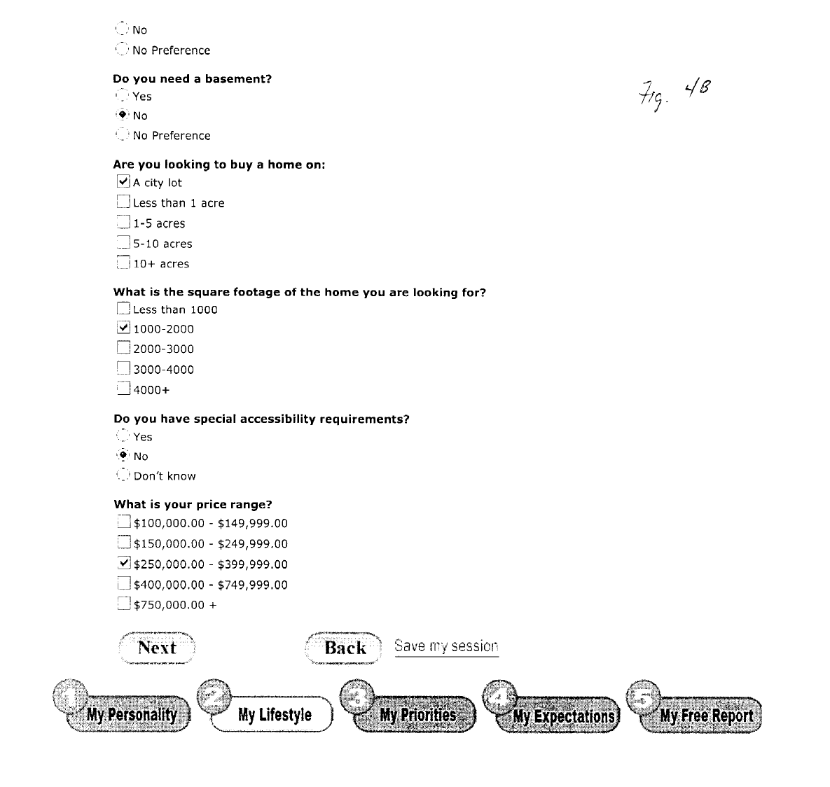

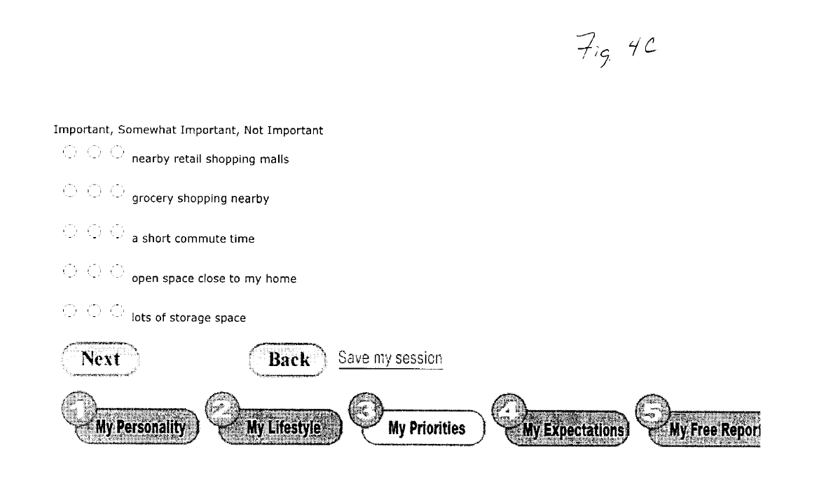

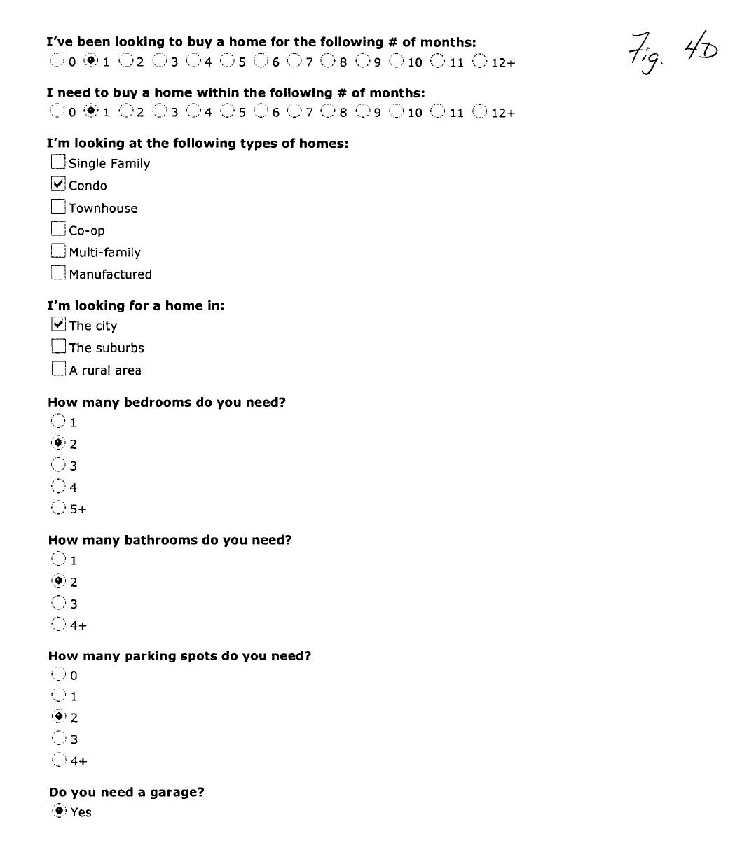

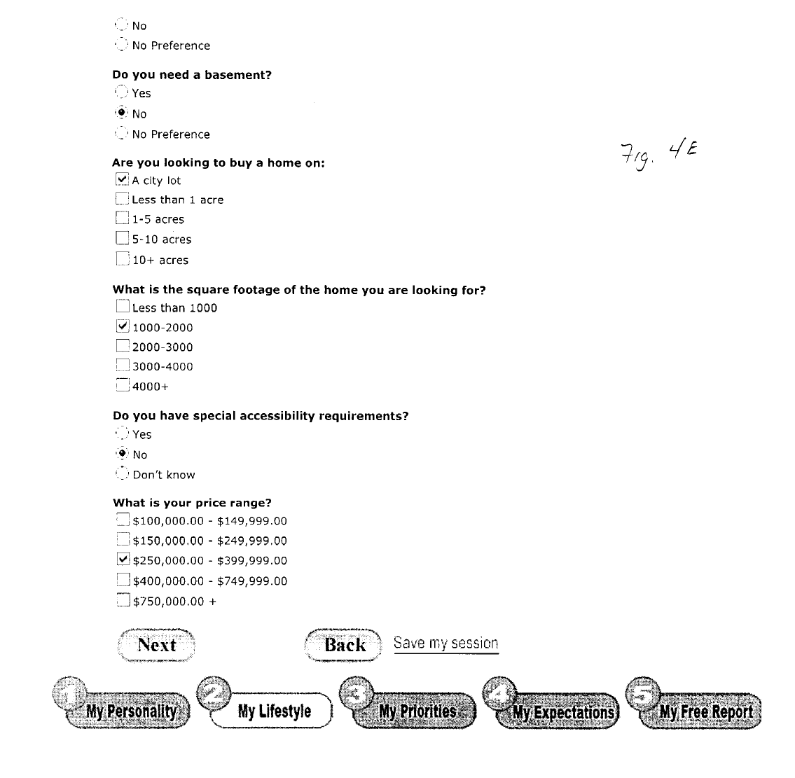

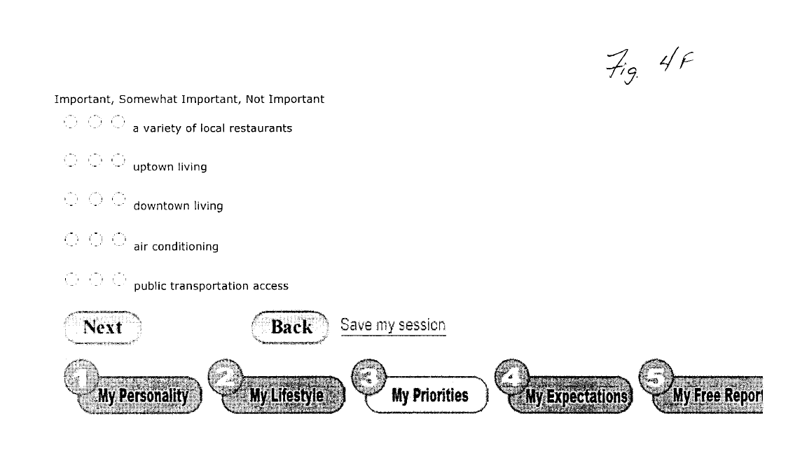

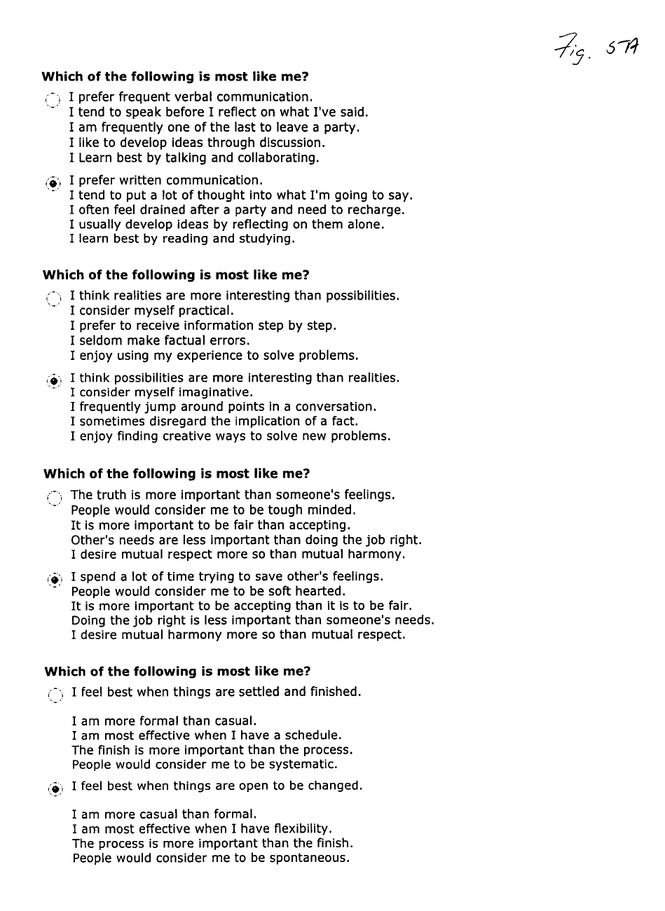

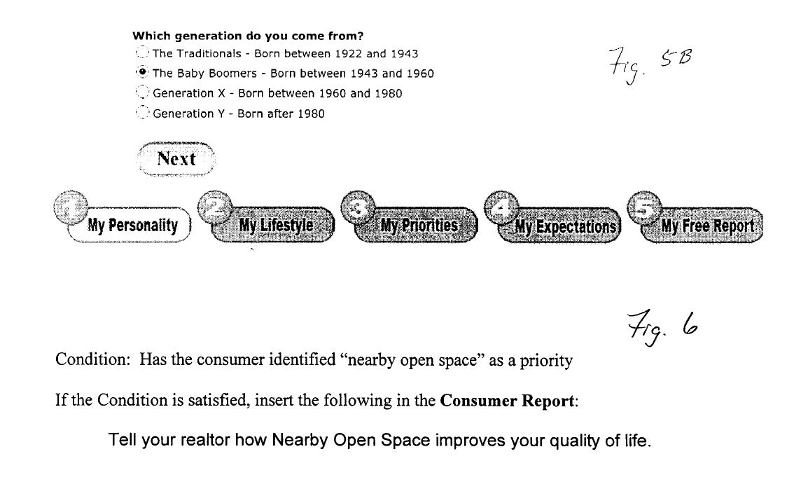

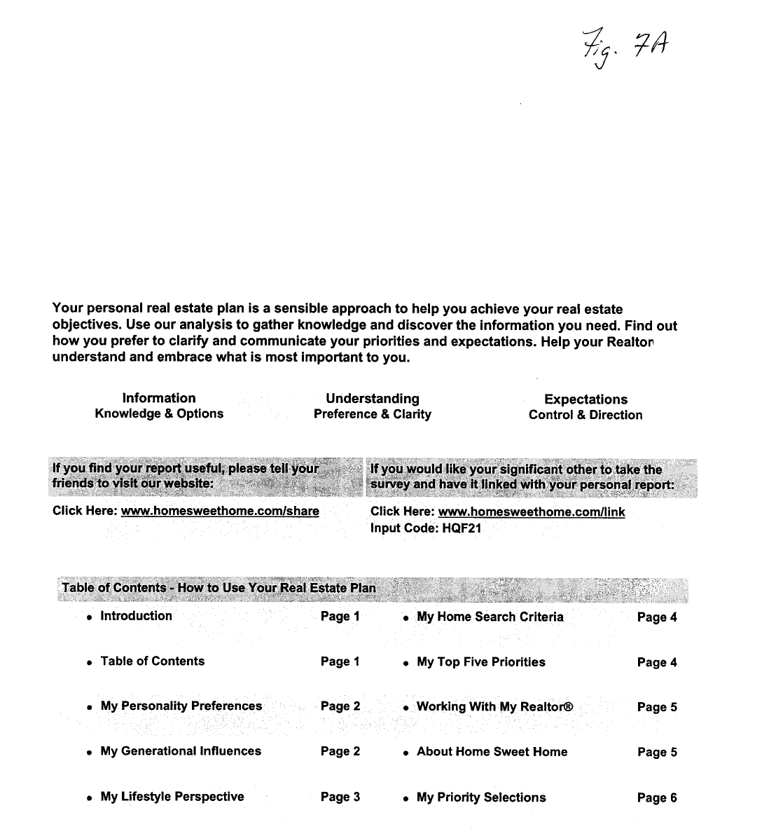

Another characteristic of the survey provided by the server 22 to the consumer computing device 24 is that one or more of the queries are designed to extract answers from the consumer that can be analyzed to determine a personality profile for the consumer. In the illustrated embodiment, the survey includes one or more queries that are Jungian in nature, i.e., designed to assess where the consumer taking the survey falls within at least one Jungian dichotomy. There are at least four Jungian dichotomies and these dichotomies are typically referred to as: (a) extraversion/introversion; (b) sensing/intuition; (c) thinking/feeling; and (d) judging/perceiving. In the context of the contemplated real estate transaction, the extraversion/introversion dichotomy relates to identifying the consumer's source of psychological energy; the sensing/intuition dichotomy relates to identifying how the consumer takes in and/or values information; the thinking/feeling dichotomy relates to identifying how the consumer makes decisions and judgments; and the judging/perceiving dichotomy relates to identifying how the consumer organizes or structures their lift. It is believed that assessing the consumer's psychological type in the context of the contemplated real estate transaction by posing Jungian-style queries and analyzing the answers to such queries provides additional depth or insight into the consumer's motivations with respect to the contemplated real estate transaction. FIGS. 5A and 5B illustrate an example of a page of a survey that is provided by the server 22 to the consumer computing device 24 that contains several queries that are each designed to provoke answers from the consumer that indicate where the consumer falls within at least one Jungian dichotomy. It should be appreciated that the survey is capable of being adapted to include one or more queries that implement another type of personality profiling or psychological typing to assess the consumer's individuality in the context of the contemplated real estate transaction and/or expectations with respect to other individuals that the consumer may utilize in investigating the contemplated real estate transaction. Other types of personality profiling or psychological typing include DISCUS (dominance, influence, steadiness, and compliance) typing, Temperament (choleric, sanguine, melancholy, phlegmatic), etc. Further, the survey can include queries that implement two or more types of personality profiling.

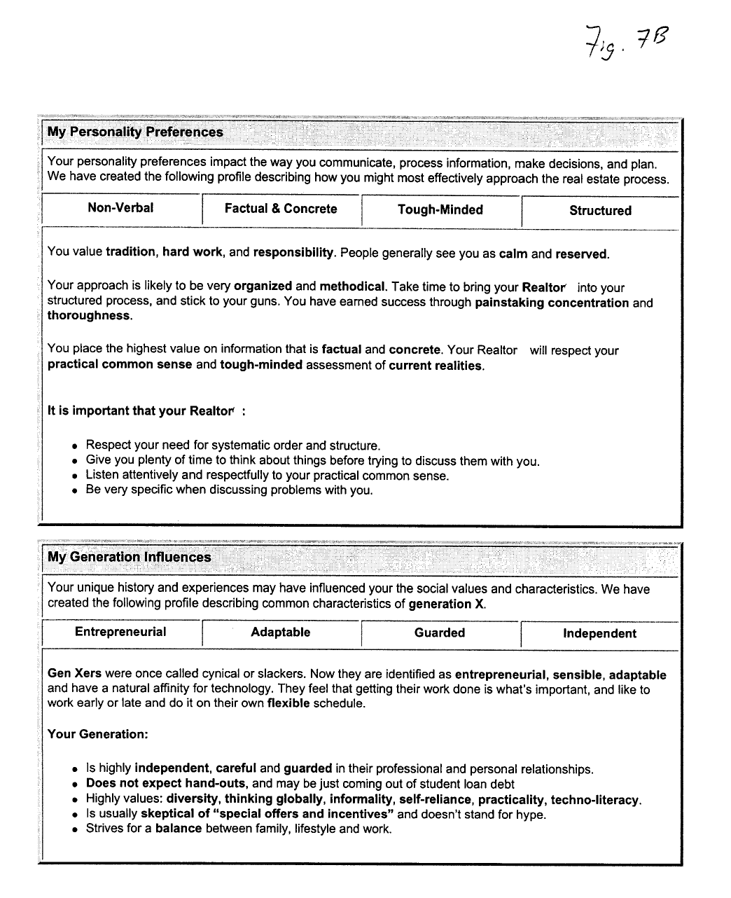

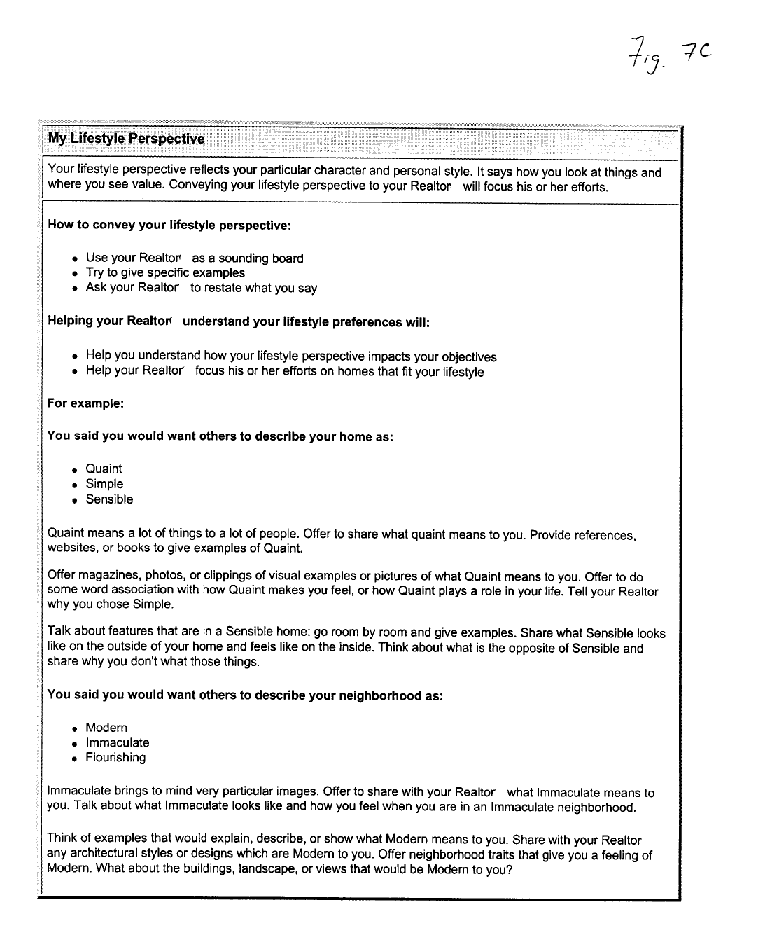

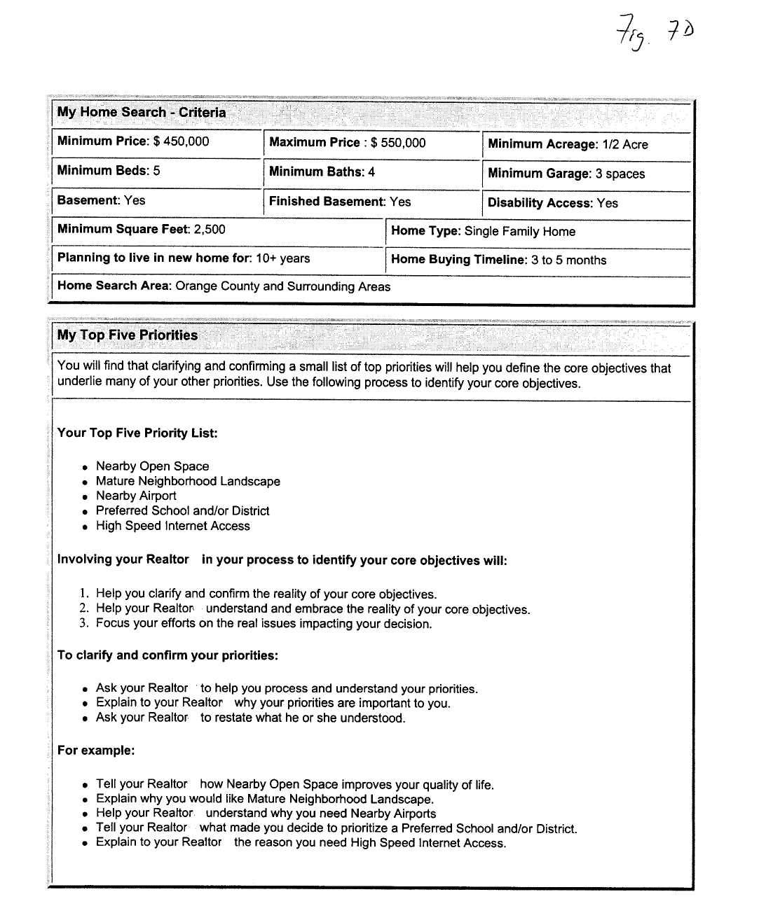

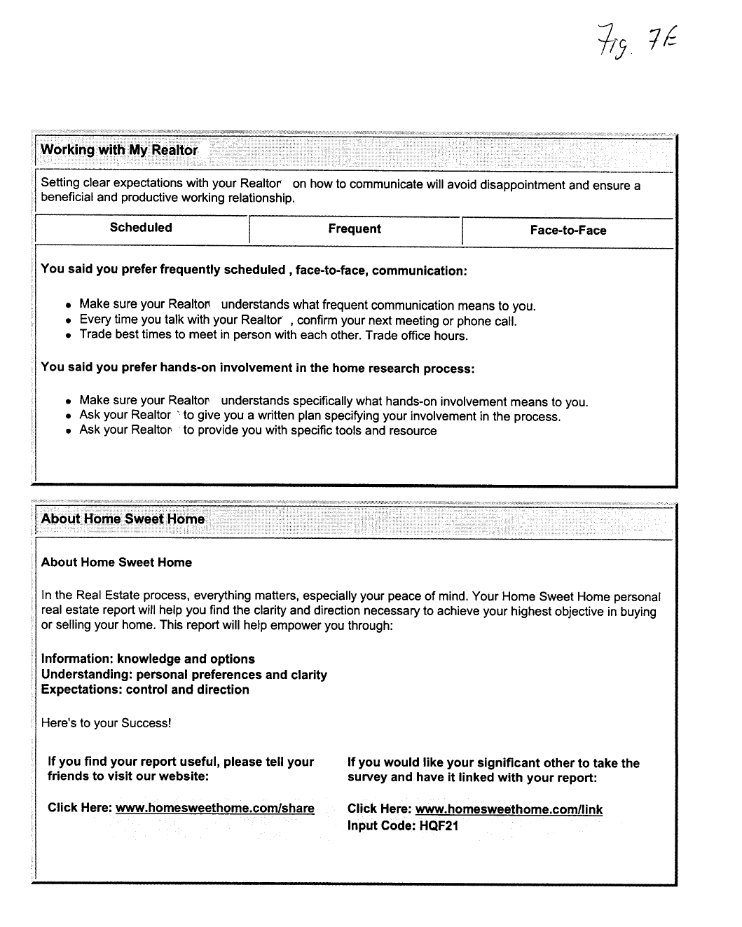

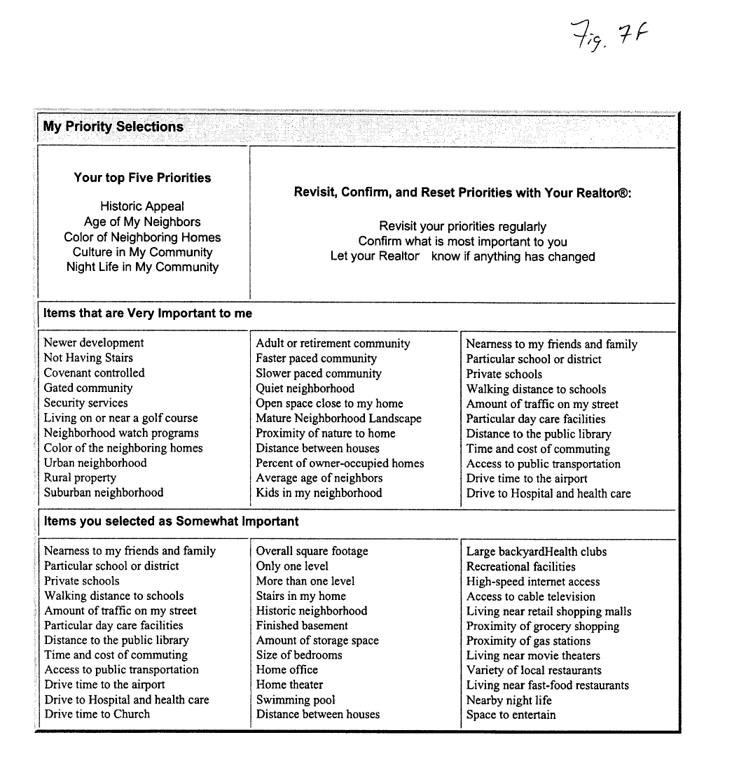

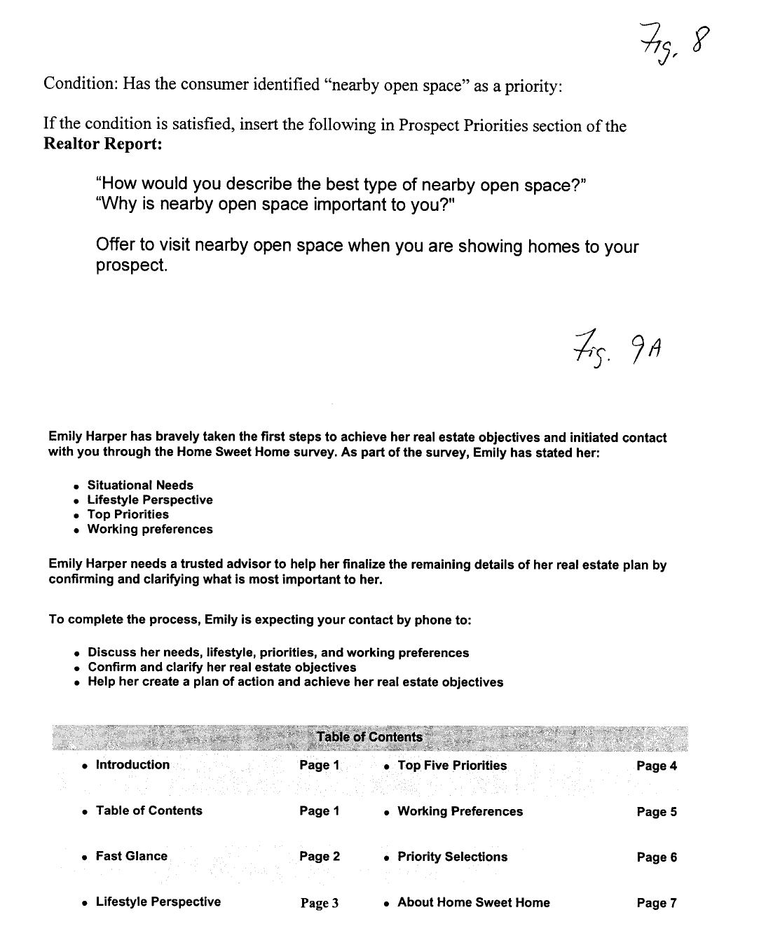

In one embodiment, the server 22 generates a report for the consumer by comparing the consumer's answer to a query, answers to a query, and/or answers to several questions to one or more conditions. Depending on whether or not the one or more conditions are satisfied, a pre-written content is inserted into a consumer report template. FIG. 6 illustrates a simple example of a condition that has been satisfied by the consumer's answer to a question and the pre-written content that is inserted into a consumer report template based on the satisfied condition. Specifically, the condition is whether the consumer has identified “nearby open space” as a priority. The consumer has identified “nearby open space” as a priority. Since the condition has been satisfied, the pre-written content, “Tell your realtor how nearby open space improves your quality of life” is inserted into the report. The condition can be based on two or more answers. For example, if there are two queries that each have two answer, (a) and (b). If the consumer selects answers (a) for both of the queries, a condition is satisfied that results in pre-written content being inserted into the report. If the consumer selects answers (a) and (b), the condition is not satisfied and no pre-written content is inserted into the report based on this condition. FIGS. 7A-7F illustrates a consumer report that is generated based upon the consumer's answers to the dynamic survey with a Jungian characteristic.

The referral step 36 comprises: (a) the consumer informing the server 22 that the consumer is interested in being referred to a real estate professional that can assist the consumer in proceeding with the contemplated real estate transaction; (b) if the consumer is interested in such a referral, providing a second version of the report that does not identify the consumer to one or more real estate referral agents for evaluating as to whether or not they want to be referred to the consumer; and (c) if a real estate referral agent wants the referral, providing the information needed for the real estate referral agent to contact the consumer.

The consumer can inform the server 22 that the consumer is interested in being referred to a real estate professional that can assist the consumer in proceeding with the contemplated real estate transaction in a number of ways. Typically, the server 22 sends an inquiry to the consumer computing device 24 inquiring as to whether or not the consumer wants to be referred to such a real estate professional and the consumer uses the user interface associated with the consumer computing device 24 to reply that there is an interest in being referred.

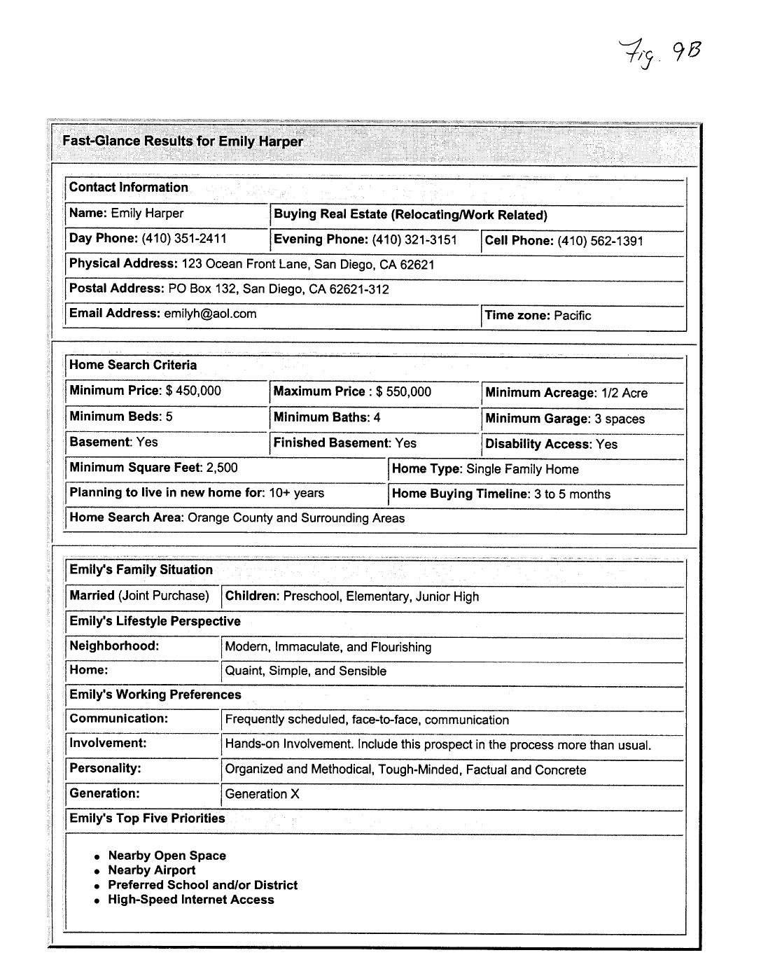

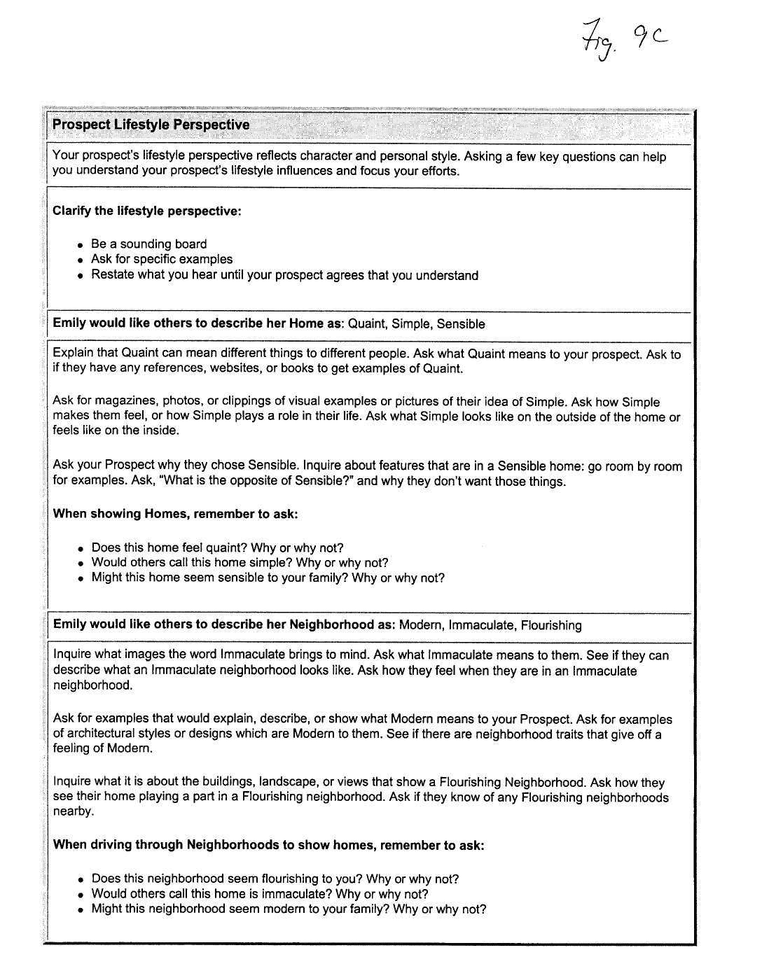

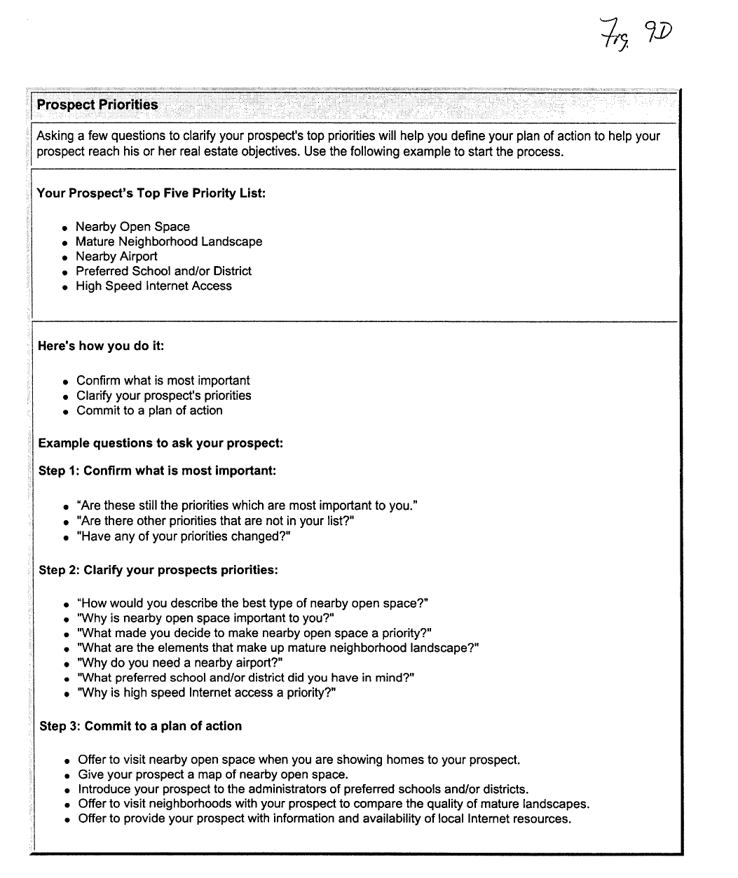

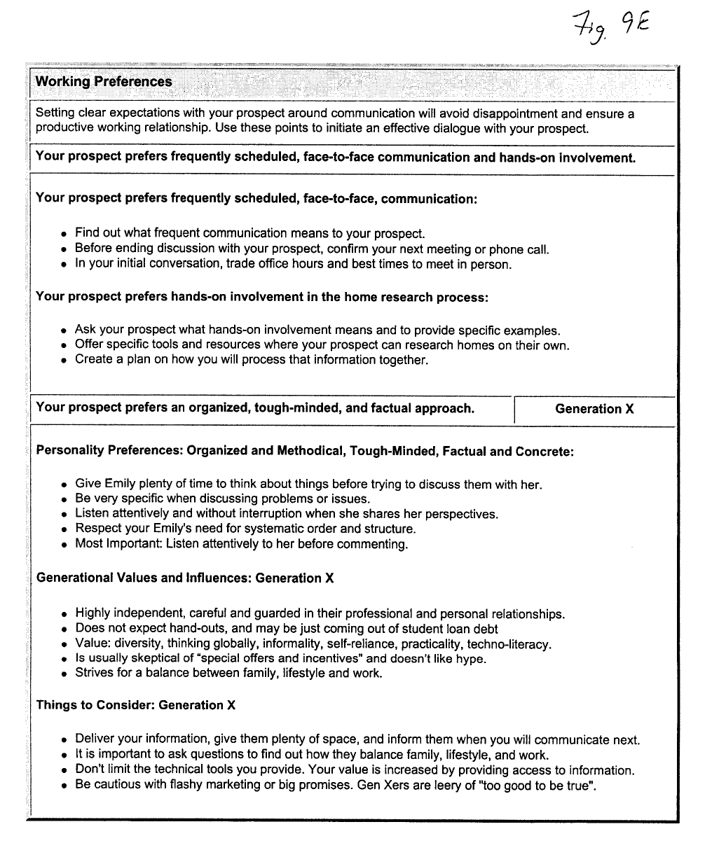

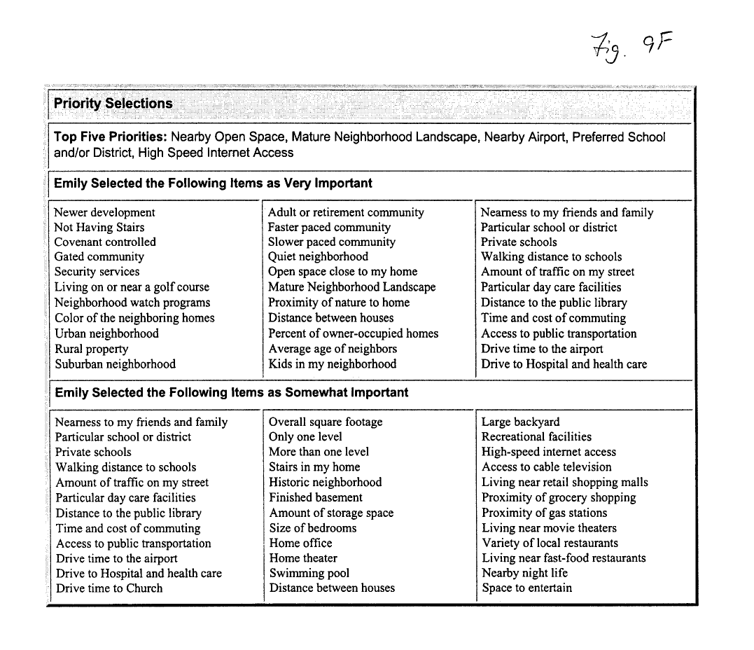

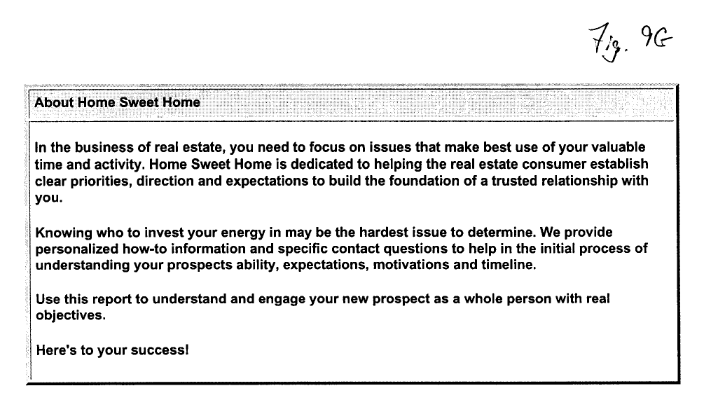

In response to a signal from the consumer that the consumer is interested in being referred, the server 22 causes transmission of a prospect report directed to the real estate referral agent computing system 26. The prospect report is conveyed by the network 28 to the real estate referral agent computing system 26. The real estate referral agent computing system 26 displays or otherwise conveys the report to the to a real estate referral agent for consideration. The report that is provided to the real estate professional is generated in substantially the same manner as the report that is provided to the consumer. Specifically, one or combination of the consumer's answers is compared to a condition. If the condition is satisfied, pre-written text is inserted into a report template. Typically, to build the report with pre-written text, this process is repeated for a number of different conditions. FIG. 8 illustrates a simple example of a condition that has been satisfied by the consumer's answer to a question and the pre-written content that is inserted into a consumer report template based on the satisfied condition. Specifically, the condition is whether the consumer has identified “nearby open space” as a priority. The consumer has identified “nearby open space” as a priority. Since the condition has been satisfied, the pre-written content noted in FIG. 8 is inserted into the report. FIGS. 9A-9G illustrate a referral agent or realtor report that is generated based upon the consumer's answers to the dynamic survey with a Jungian characteristic. It should be noted that the prospect report that is provided to the referral agent or real estate professional contains different information than the consumer report. Specifically, the prospect report contains information that sets forth the consumer's expectations with respect to any real estate professional that is engaged to aid the consumer in moving the contemplated transaction forward.

The real estate referral agent is given a certain amount of time to provide an answer, via the real estate referral agent computing device 26 and the network 28, to the server 22 as to whether or not referral is accepted. If the referral is accepted by an appropriate communication from the real estate referral agent computing device 26 to the server 22, the server 22 causes transmission of the consumer's contact information to be directed to the real estate referral agent computing device 26. If the referral is either affirmatively not accepted or the time limit for responding expires, the server 22 causes the referral to be directed to the real estate referral agent computing device associated with an another real estate referral agent. This process continues until a real estate referral agent affirmatively indicates acceptance of the referral to the server via an appropriate communication that is transmitted from the real estate referral agent computing device 26 to the server 22. Once a referral agent accepts a referral, the referral agent must contact the referral within a specified amount of time and log the contact by communicating with a referral management web-site associated with the server 22 or another server. The referral management web-site is used to monitor the progress of the consumer with respect to the contemplated real estate transaction.

In addition, once a real estate referral agent has accepted the referral, the real estate agent has several options with respect to the manner in which the referral is handled. The referral agent can handle the referral himself or herself. Alternatively, the referral agent can refer, in turn, the prospect to a receiving agent, i.e., another real estate professional that may be more qualified to facilitate the real estate transaction contemplated by the consumer. The real estate referral agent can be any of a number of different professionals involved in the real estate industry. For instance, the real estate referral agent can be a real estate broker or a lender. Further, the receiving agent can be a real estate broker or a lender. In any event, the referral agent or receiving agent that ultimately works with the referral is obliged to provide the management web-site updates that allow the consumer's progress towards consummating the contemplated real estate transaction to be monitored.

The payment step can take a number of forms. The referral agent can pay a subscription fee to receive prospect reports; the referral agent can pay a unit fee for each prospect report received; the referral agent can pay a percentage of the fee that the agent earns on the closing of the contemplated transaction by the consumer; or a combination of any of the foregoing payment methods.

What is claimed is:

1. A method for operating a Web server to facilitate a real estate transaction comprising:
receiving an initiate survey signal from a user computing device, said initiate survey signal indicating that a user associated with the user computing device wants to take a survey that may facilitate a predetermined type of real estate transaction;
first causing, in response to said initiate survey signal, a transmission of a first query relating to a predetermined type of real estate transaction to be directed to the user computing device;
first receiving a first answer of the user to said first query from the user computing device;
processing said first answer to determine, based on said first answer, a second query relating to said predetermined type of real estate transaction; and
second causing a transmission of said second query relating to said predetermined type of real estate transaction to be directed to the user computing device.

2. A method, as claimed in claim 1, wherein:
said step of processing comprises using said first answer to eliminate a second query from a set of two or more possible second queries and thereby define a remaining set of possible second queries.

3. A method, as claimed in claim 2, wherein:
said step of processing comprises identifying said remaining set of possible second queries as said second query.

4. A method, as claimed in claim 1, wherein:
said step of processing comprises using said first answer to eliminate a plurality of second queries from a set of three or more possible second queries and thereby define a remaining set of possible second queries.

5. A method, as claimed in claim 4, wherein:
said step of processing comprises identifying said remaining set of possible second queries as said second query.

6. A method, as claimed in claim 1, wherein:
said step of processing comprises using said first answer to eliminate all but one of a plurality of second queries from a set of two or more possible second queries and thereby define a set of one possible second query.

7. A method, as claimed in claim 1, wherein:
said step of processing comprises using said first answer in constructing said second query.

8. A method, as claimed in claim 1, wherein:
at least one of said first and second queries is a personality profiling query.

9. A method, as claimed in claim 1, wherein:
said predetermined type of real estates transaction comprises one of: a real estate purchase transaction, a real estate sales transaction, and a real estate lease transaction.

10. A method for operating a user computing device to facilitate a real estate transaction comprising:
causing an initiate survey signal to be transmitted from the user computing device and directed to a Web server that is adapted to process said initiate survey signal, said initiate survey signal indicating that a user associated with the user computing device is interested in taking a survey that may facilitate a predetermined type of real estate transaction that the user may be contemplating;
first receiving, in response to said initiate survey signal, a first query relating to said predetermined type of real estate transaction from the Web server;
first causing a first answer of the user to said first query to be transmitted from the user computing device and directed to the Web server; and
second receiving, in response to said first answer, a second query relating to said predetermined type of real estate transaction that has been determined by the Web server based on said first answer.

11. A method, as claimed in claim 10, wherein:
said first query is designed to facilitate an assessment of the user's personality.

12. A method, as claimed in claim 10, wherein:
said first query is designed to facilitate an assessment of the user's personality with respect to a Jungian dichotomy.

13. A method, as claimed in claim 12, wherein:
said Jungian dichotomy is one of the following: extraversion/introversion, sensing/intuition, thinking/feeling, and judging/perceiving.

14. A method, as claimed in claim 11, wherein:
said second query is designed to facilitate an assessment of the user's personality.

15. A method, as claimed in claim 11, wherein:
said second query relates to the user's expectations with respect to a real estate person that may assist in the real estate transaction that the user may be contemplating.

16. A method, as claimed in claim 10, wherein:
said first query relates to the user's expectations with respect to a real estate person that may assist in the real estate transaction that the user may be contemplating.

17. A method, as claimed in claim 16, wherein:
said second query relates to the user's expectations with respect to a real estate person that may assist in the real estate transaction that the user may be contemplating.

18. A method for facilitating a real estate transaction comprising:
conveying an initiate survey signal, originating from a user computing device, towards a Web server adapted to process said initiate survey signal, the initiate survey signal indicating that a user associated with the user computing device wants to take a survey that may facilitate a predetermined type of real estate transaction that the user may be contemplating;
first conveying a first query relating to said predetermined type of real estate transaction that originated with the Web server and is in response to said initiate survey signal towards the user computing device;
first conveying a first answer of the user to said first query that originated with the user computing device towards the Web server; and
second conveying a second query relating to said predetermined type of real estate transaction that originated with the Web server towards the user computing device, said second query having been determined by the Web server based on said first answer.

19. A method, as claimed in claim 18, wherein:
said first query relates to at least one of the user's personality, lifestyle, and priorities in the context of said predetermined type of real estate transaction.

20. A method, as claimed in claim 19, wherein:
said second query relates to at least one of the user's personality, lifestyle, priorities in the context of said predetermined type of real estate transaction.

21. A method, as claimed in claim 19, wherein:
said second query relates to answer relates to the user's expectations with respect to a real estate person that may assist in said predetermined type of real estate transaction.

22. A method, as claimed in claim 18, wherein:
said predetermined type of real estates transaction comprises a lease.

23. A method for operating a Web server to facilitate a real estate transaction comprising:
receiving an initiate survey signal from a user computing device, the initiate survey signal indicating that a user associated with the user computing device wants to take a survey that may facilitate real estate transaction that the user may be contemplating;
causing, in response to said initiate survey signal, transmission of a plurality of queries directed to the user computing device, said plurality of queries having a personality profiling characteristic in which at least one of said plurality of queries is designed to assess the user's personality type;
receiving an answer of the user to each query of said plurality of queries from the user computing device;
processing a plurality of said answers to said plurality of queries to produce a report for the user that may facilitate the real estate transaction that the user may be contemplating; and
causing transmission of said report from the Web server and directed to the user computing device.

24. A method, as claimed in claim 23, wherein:
said step of causing transmission of a plurality of queries comprises causing transmission of at least one query that is designed to assess the user's personality with respect to a Jungian dichotomy.

25. A method, as claimed in claim 23, wherein:
said step of causing comprises causing transmission of a sequence of at least three queries.

26. A method, as claimed in claim 25, wherein:
said step of causing comprises causing transmission of a query in said sequence other than said first or second query in said sequence that is determined based upon an answer to a prior query in said sequence.

27. A method, as claimed in claim 26, wherein:
said step of causing transmission of a plurality of queries directed to the user computing device comprises causing multiple transmissions in which each transmission has a least one query.

28. A method, as claimed in claim 23, further comprising:
causing transmission of said report from the Web server and directed to a computing device associated with a real estate professional.
